(19) United States
(12) Patent Application Publication
(10) Pub. No.: US 2025/0125542 A1
(43) Pub. Date: Apr. 17, 2025

(54) HORIZONTAL INSULATION PIERCING CONNECTOR WITH PARALLEL CONNECTOR BLADES

(71) Applicant: Hubbell Incorporated, Shelton, CT (US)

(72) Inventor: Colin Marshall Alexander Rebhun, Manchester, NH (US)

(21) Appl. No.: 18/917,082

(22) Filed: Oct. 16, 2024

Related U.S. Application Data
(60) Provisional application No. 63/590,599, filed on Oct. 16, 2023.

(51) Int. Cl. H01R 4/44; H01R 4/48; H01R 13/621

(52) U.S. Cl. CPC H01R 4/44; H01R 4/489; H01R 13/621

(57) ABSTRACT

An electrical connector includes a first pad with a first conductor groove and a second conductor groove. A second pad having a third conductor groove and a fourth conductor groove is movably connected to the first pad by a fastener. A first contact is connected to the first pad. The first contact has a first set of teeth that extend into the first groove and a second set of teeth that extend into the second groove. A first contact gasket is connected to the first pad and positioned over the first contact. A second contact is connected to the second pad. The second contact has a third set of teeth that extend into the third groove and a fourth set of teeth that extend into the fourth groove. A second contact gasket is connected to the second pad and positioned over the second contact.

### RELATED APPLICATION(S)

This application is based on U.S. Provisional Application Ser. No. 63/590,599, filed Oct. 16, 2023, the disclosure of which is incorporated herein by reference in its entirety and to which priority is claimed.

### FIELD

Various exemplary embodiments relate to an electrical connector for electrically connecting various diameter first and second conductors

### BACKGROUND

Power line clamp connectors are used to make a permanent or temporary connection to an overhead power distribution line. Parallel cable clamps are configured to electrically connect a main conductor to a tap conductor running parallel to the main conductor. A parallel cable clamp typically includes a top half and a bottom half, each having a first groove for receiving the main conductor and a second groove for receiving the tap conductor. The top and bottom halves are typically held together by a mechanical fastener.

### SUMMARY

In certain configurations, an electrical connector includes a first pad with a first conductor groove and a second conductor groove. A second pad having a third conductor groove and a fourth conductor groove is movably connected to the first pad by a fastener. An electrically conductive first contact is connected to the first pad. The first contact has a first set of teeth that extend into the first groove and a second set of teeth that extend into the second groove. A first contact gasket is connected to the first pad and positioned over the first contact. The first contact gasket has a first slot aligned with the first set of teeth and a second slot aligned with the second set of teeth. An electrically conductive second contact is connected to the second pad. The second contact has a third set of teeth that extend into the third groove and a fourth set of teeth that extend into the fourth groove. A second contact gasket is connected to the second pad and positioned over the second contact. The second contact gasket has a third slot aligned with the third set of teeth and a fourth slot aligned with the fourth set of teeth.

In certain configurations, an electrical connector includes a first pad and a second movably connected to the first pad by a fastener. An electrically conductive first contact is connected to the first pad, the first contact having a first set of teeth and a second set of teeth. A first contact gasket is connected to the first pad and positioned over the first contact. The first contact gasket includes a first curved portion for receiving a first conductor, a second curved portion for receiving a second conductor, a first slot aligned with the first set of teeth, and a second slot aligned with the second set of teeth. An electrically conductive second contact is connected to the second pad. The second contact includes a third set of teeth and a fourth set of teeth. A second contact gasket is connected to the second pad and positioned over the second contact. The second contact gasket includes a third slot aligned with the third set of teeth and a fourth slot aligned with the fourth set of teeth.

### BRIEF DESCRIPTION OF THE DRAWINGS

The aspects and features of various exemplary embodiments will be more apparent from the description of those exemplary embodiments taken with reference to the accompanying drawings.

FIG. 1 is a top perspective view of an insulation piercing electrical connector.

FIG. 2 is a side view of the connector of FIG. 1.

FIG. 3 is a sectional view of FIG. 2.

FIG. 4 is a top perspective view of the first pad, first contact gasket, and first contacts.

FIG. 5 is a bottom perspective view of FIG. 4.

FIG. 6 is an exploded view of FIG. 4.

FIG. 7 is a top perspective view of the contact gasket.

FIG. 8 is a bottom perspective view of FIG. 7.

FIG. 9 is a bottom perspective view of the second pad, second contact gasket, and second contacts.

FIG. 10 is a top perspective view of FIG. 9.

FIG. 11 is an exploded view of FIG. 9.

FIG. 12 is a top, front perspective view of another insulation piercing electrical connector.

FIG. 13 is a top, rear perspective view of another insulation piercing electrical connector.

FIG. 14 is a bottom perspective view of the first pad of FIG. 12.

FIG. 15 is a top perspective view of FIG. 14.

FIG. 16 is an exploded view of the first pad, first contact gasket, and first contacts FIG. 12.

FIG. 17 is a top perspective view of the contact gasket of FIG. 16.

FIG. 18 is a bottom perspective view of FIG. 17.

FIG. 19 is a bottom perspective view of the second pad of FIG. 12.

FIG. 20 is a top perspective view of FIG. 19.

FIG. 21 is an exploded view of the second pad, second contact gasket, and second contacts FIG. 12.

FIG. 22 is a sectional view of the insulation piercing electrical connector in a fully closed position.

FIG. 23 is an enlarged, partial view of the teeth and cable groove area of FIG. 22.

FIG. 24 is a sectional view of the insulation piercing electrical connector in an open position.

FIG. 25 is a sectional view of the insulation piercing electrical connector clamping a primary and secondary conductor.

### DETAILED DESCRIPTION OF EXEMPLARY EMBODIMENTS

In various implementations, a parallel groove, insulation piercing connector clamp can be used for tap, splice, and dead-end connections in various utility line operations. The clamp can include a pair of pads, with each pad having a connector body with a first groove to make a primary connection and a second groove to make a tap connection. A fastener can extend through the pads to connect the pads and allow for the clamp to be tightened onto one or more electrical conductors. Teeth can be provided so that the clamp will pierce conductor insulation so that a lineman need not strip a cable to make an electrical connection.

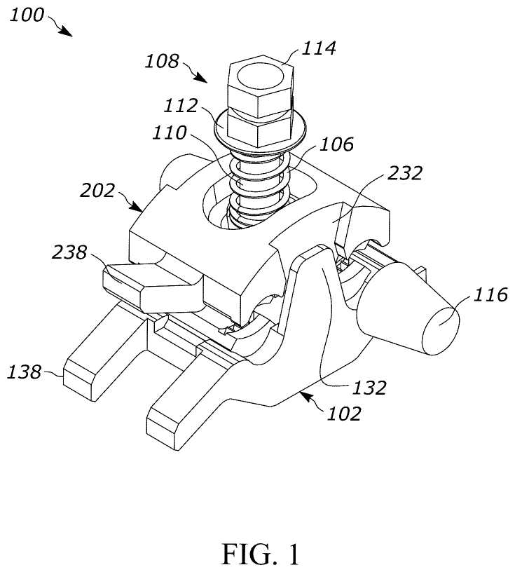

FIGS. 1-3 show an exemplary configuration of a connector 100 having a first pad 102, a second pad 202, a spring member 106, and a fastener 108. The fastener 108 secures the spring member 106 against the second pad 202 to bias the first and second pads 102, 202 toward one another. The spring member 106 also provides a clamping force to secure first and second conductors between the first and second pads 102, 202.

The fastener 108 can include a bolt 110, a washer 112, and a shear nut 114. The shear nut 114 can include an upper engagement portion, a frangible section, and a lower engagement portion. A tool can be used to tightening the shear nut 114 using the upper engagement portion until a certain torque limit is reached and the frangible section shears to remove the upper engagement portion. This helps prevent overtightening of the fastener which can cause damage to the connector or to the conductors.

One or more conductor seals 116 can also be utilized with the connector 100. The conductor seals 116 can be placed over an exposed portion of a conductor. For example, the free end of the tap conductor can have an exposed end without insulation. The conductor seal 116 can be used to cover that free end to prevent water or debris from entering the tap line which can lead to corrosion.

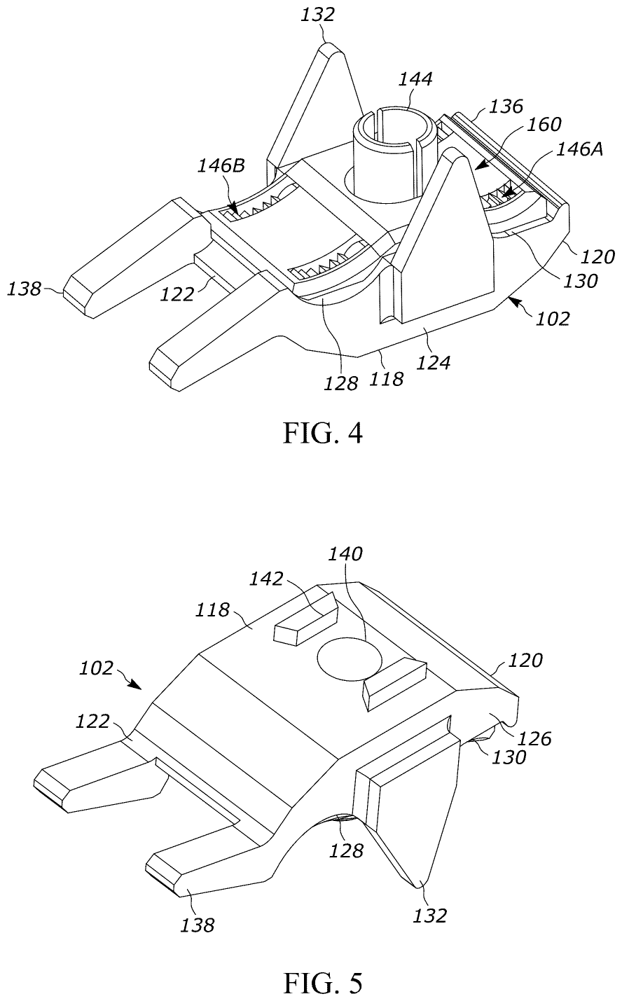

FIGS. 4-6 show an exemplary configuration of the first pad 102 having an outer surface 120, a first end 122, a second end 122, a first side 124, and a second side 126. The first pad 102 can be a one-piece member or can be made from multiple connected components. The first pad 102 can be fabricated from an electrically conductive material, for example metal, or from a non-electrically conductive material, such as a polymer or composite material. The first pad 102 includes a first conductor groove 128 and a second conductor groove 130. The first and second conductor grooves 128, 130, are substantially parallel to one another and are configured to receive the first and second conductors respectively. The first and second conductor grooves 128, 130 are arcuate or partially cylindrical grooves extending between the first side 124 and the second side 126. In various configurations, the size, shape, length, and orientation of the first and second conductor grooves can vary, for example, depending on the type of conductors to be connected and the direction in which the conductors are to run.

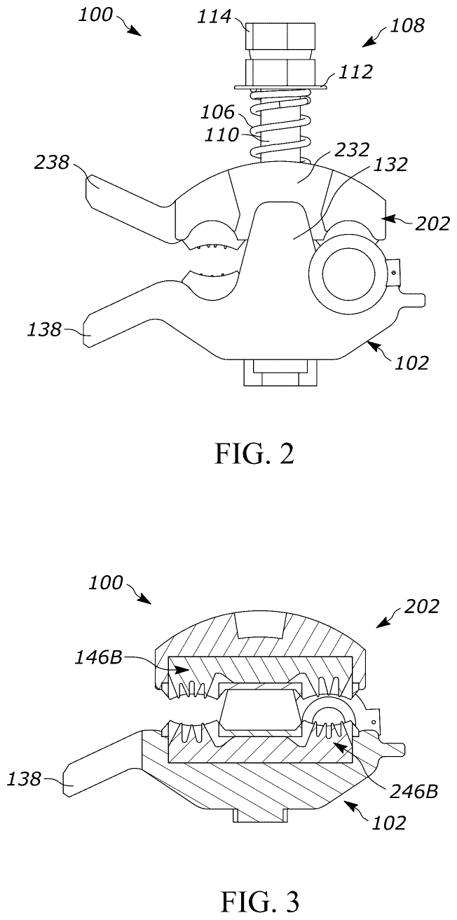

Each side of the first pad 102 can include an upwardly extending projection 132. The projection 132 can extend between the first conductor groove 128 and the second conductor groove 130. The projections 132 can have a substantially triangular configuration with a rounded point. The projections 132 fit in respective grooves 232 on the sides of the second pad 202 as shown in FIGS. 1 and 2. The projections 132 and grooves 232 help restrain pivoting movement of the first and second pad 102, 202 relative to each.

The first end 120 of the first pad 102 can include a raised lip 136 extending from the first conductor groove 128. The second end 122 of the first pad 102 can include one or more legs 138 extending at an oblique angle from a lower surface. The angle of the legs 138 allows a user to grip the outer surface and apply pressure to pivot the first and second pads 102, 202 with respect to each other.

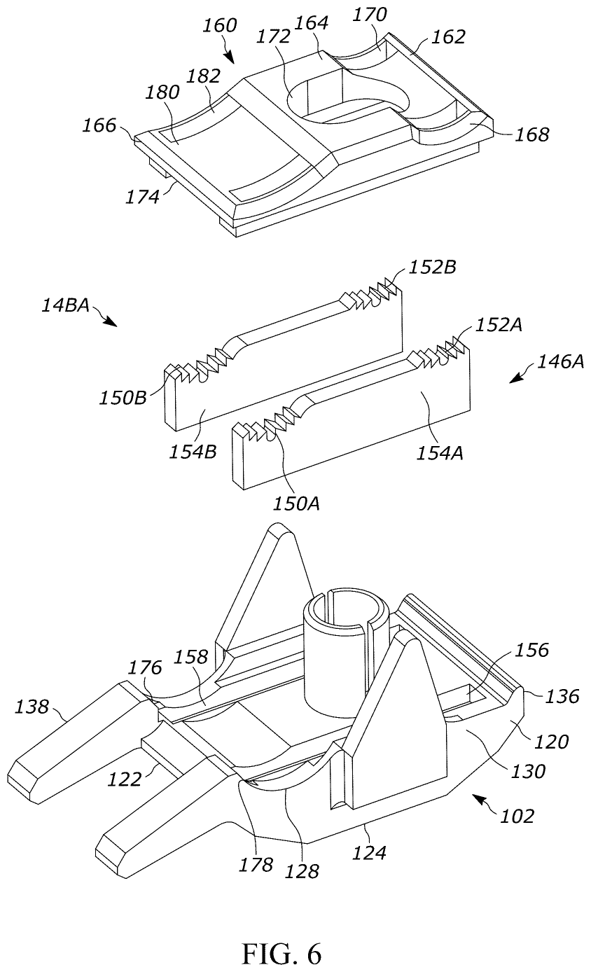

As best shown in FIG. 5, the first pad 102 includes a fastener opening 140 extending through the outer surface 118 to receive the bolt 110. A pair of projections 142 extend from the outer surface 118 proximate the opening 140. The projections 142 can help to retain the head of the bolt 110 to prevent rotation when the sheer nut 114 is being tightened without the need to use a separate tool. A sleeve 144 extends from the inner portion of the first pad 102 (as shown in FIGS. 4 and 6) opposite the opening 140. The sleeve 144 has a hollow cylindrical body that receives the fastener bolt 110. The sleeve 144 can vary in size and shape depending on the type of fastener 108 used to connect the first and second pads 102, 202. In certain configurations, the sleeve 144 is integrally formed with the first pad 102.

At least one insulation displacing contact can be connected to the first pad 102. As shown in FIGS. 4 and 6, a first contact 146A extends between the first conductor groove 128 and the second conductor groove 130 on a first side of the first pad 102. A second contact 146B extends between the first conductor groove 128 and the second conductor groove 130 on a second side of the first pad 102. Each contact 146A, 146B includes a first set of teeth 150A, 150B, a second set of teeth 152A, 152B, and a central portion 154A, 154B, bridging the first teeth 150A, 150B and second teeth 152A, 152B. The first and second insulation displacing contacts 146A, 146B are depicted as single piece or unitary contacts that create an electrical connection between the first and second conductor grooves 128, 130, although a multi-piece contact may also be used.

In certain configurations, the first pad 102 can include a first slot 156 for receiving the first contact 146A and a second slot 158 for receiving the second contact 146B as best shown in FIG. 6. The first and second slots 156, 158 extend into the first pad 102 and from the first conductor groove 128 to the second conductor groove 130 on either side of the sleeve 144. The first and second slots 156, 158 can be blind slots that extend into an inner surface of the first pad 102 in a stepped fashion.

The insulation displacing contacts 146A, 146B facilitate engaging an insulated conductor and displacing the insulation. In certain applications, the teeth are designed to pierce the insulation of a respective conductor. The electrical connector also may be used with conductors that do not have insulation, and the insulation displacing contacts may be used to grip or retain the conductor.

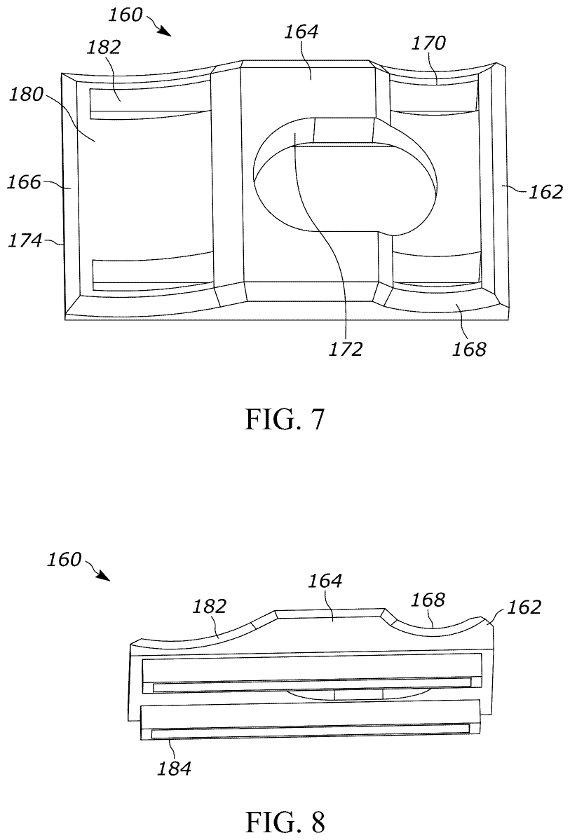

In certain configurations, a first contact gasket 160 is connected to the first pad 102. As best shown in FIGS. 7 and 8, the contact gasket 160 includes a front portion 162, a central region 164, and a rear portion 166. The front portion 162 can be positioned inside of the lip 136 of the first pad 102 and can be in engagement with the lip 136 to help hold the gasket 160 in place. The front portion 162 includes a curved section 168 corresponding with the second conductor groove 130. A pair of slots 170 are formed in opposite sides of the gasket 160 to receive the second conductor groove teeth 152A, 152B of the contacts 146A, 146B. The first gasket 160 can be configured so that in an unstressed position the teeth 152A, 152B do not extend outside the slots 170, but are positioned below an outer edge surrounding the slots 170. In other configurations, the teeth 152A, 152B can extend partially outside of the slots 170 with a substantial portion of the teeth 152A, 152B below the outer edge.

The central region 164 extends between the front portion 162 and the rear portion 166. The central region 164 includes a raised surface that extends above sections of the front portion 162 and the rear portion 166. An opening 172 extends through the central region 164 and into the front portion 164 to receive the sleeve 144. The opening 172 has an oval or obround configuration to allow for movement of the sleeve 144 in the opening.

The rear portion 166 of the first contact gasket 160 can include a rear edge 174. Portions of the rear edge 174 can be received in a first side recess 176 and a second side recess 178 formed in the first pad 102 (as best shown in FIG. 6) to help hold the gasket 160 in place. The rear portion 166 includes a curved section 180 corresponding with the first conductor groove 128. A pair of slots 182 are formed in opposite sides of the gasket 160 to receive the first conductor groove teeth 150A, 150B of the contacts. The first gasket 160 can be configured so that in an unstressed position the teeth 1502A, 150B do not extend outside the slots 182, but are positioned below an outer edge surrounding the slots 182. In other configurations, the teeth 150A, 150B can extend partially outside of the slots 182 with a substantial portion of the teeth 150A, 150B below the outer edge.

As shown in FIG. 8, a lower portion of the first contact gasket 160 includes a pair of tongues 184 configured to be received in the contact slots 156, 158 of the first pad 102. The tongues 184 have a substantially rectangular configuration and extend away from the upper surface of the first contact gasket 160. The tongues 184 can have a hollow section and be in communication with the slots 170, 182 on the respective sides of the first contact gasket 160.

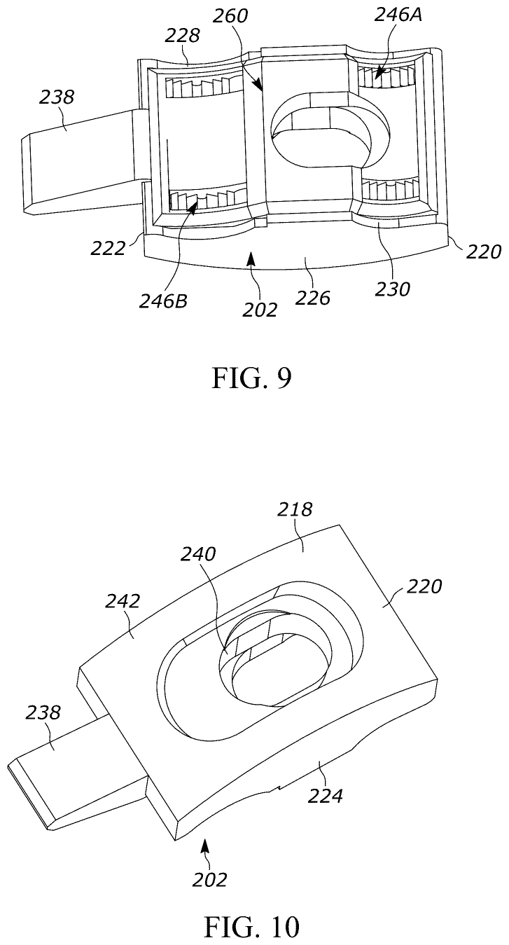

As best shown in FIGS. 9-11, the second pad 202 includes an outer surface 218, a first end 220, a second end 222, a first side 224, and a second side 226. The second pad 202 may be a one-piece member. The second pad 202 may be fabricated from an electrically conductive material, for example metal, or from a non-electrically conductive material, such as a polymer or composite material. The second pad 202 includes a first conductor groove 228 and a second conductor groove 230. The first and second conductor grooves 228, 230, are substantially parallel to one another and are configured to receive the first and second conductors respectively. The first and second conductor grooves 228, 230 are arcuate or partially cylindrical grooves extending between the first side 224 and the second side 226. In various configurations, the size, shape, length, and orientation of the first and second conductor grooves 228, 230 can vary, for example, depending on the type of conductors to be connected and the direction in which the conductors are to run.

The front 220 of the second pad 202 can include a raised lip 236 extending from the first conductor groove 228. The rear 222 of the second pad 202 can include a leg 238 extending at an oblique angle from an upper surface. The angle of the leg 238 allows a user to grip the outer surface and apply pressure to pivot the first and second pads 102, 202 with respect to each other.

As best shown in FIG. 10, the second pad 202 includes a fastener opening 240 extending through an outer surface to receive the bolt 110. A recess 242 is formed around the opening 240. The recess 242 has an obround shape and is configured to receive the washer and shear nut of the fastener.

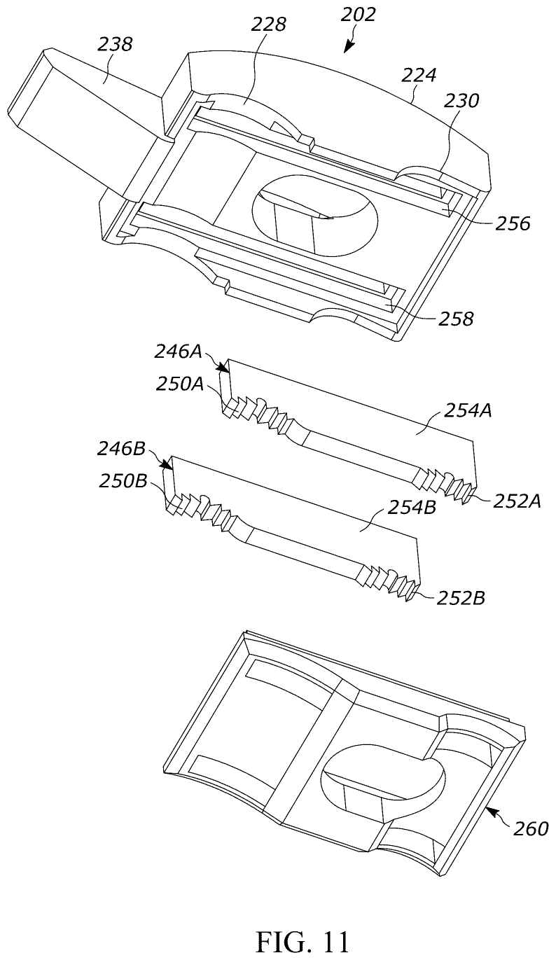

At least one insulation displacing contact can be connected to the second pad 202. As shown in FIG. 11, a first contact 246A extends between the first conductor groove 228 and the second conductor groove 230 on a first side of the second pad 202. A second contact 246B extends between the first conductor groove 228 and the second conductor groove 230 on a second side of the second pad 202. Each contact 246A, 246B includes a first set of teeth 250A, 250B, a second set of teeth 252A, 252B, and a central portion 254, bridging the first teeth 250A, 250B and second teeth 252A, 252B. The first and second insulation displacing contacts 246A, 246B are depicted as single piece or unitary contacts that create an electrical connection between the first and second conductor grooves 228, 230, although a multi-piece contact may also be used.

In certain configurations, the second pad 202 can include a first slot 256 for receiving the first contact 246A and a second slot 258 for receiving the second contact 246B as best shown in FIG. 11. The first and second slots 256, 258 extend into the second pad 202 and from the first conductor groove 228 to the second conductor groove 238 on either side of the fastener opening 240. The first and second slots 256, 258 can be blind slots that extend into an inner surface of the first pad 202 in a stepped fashion.

In certain configurations, a second contact gasket 260 is connected to the second pad 202. The second contact gasket 260 can have a configuration similar or identical to the first contact gasket 160 shown in FIGS. 6-8. In some configurations, the first contact gasket 160 and/or second contact gasket 260 can be different than what is shown based on the application and the conductors to be connected.

In operation, the first and second pads 102, 202 are assembled together to form a spring-loaded connector 100. The first conductor grooves 128, 228 are aligned to form a receiving area for a first conductor. The second conductor 130, 230 grooves are aligned to form a receiving area for the second conductor. The spring 106 applies pressure against the second pad 202, forcing or biasing the first and second pads 102, 202 together. The first and second pads 102, 202 can be separated by overcoming the pressure exerted by the spring member 106 to allow for installation of the conductors between the conductor grooves of the first and second pads 102, 202. As the first and second pads 102, 202 are forced against each other by the spring member 106, pressure is created on the conductors such that the insulation displacing contacts 146A,B 246A,B engage the conductors to secure the conductors in the conductor grooves 128, 130, 228, 230.

The force of the spring member 106 may also be sufficient for the teeth 150A,B 152A,B 250A,B 252A,B to pierce the insulation of the conductor. During this operation, the contact gaskets 160, 260 can be compressed so that the teeth 150A,B 152A,B 250A,B 252A,B extend out from the respective slots 170, 182 and engage the conductor, piercing the insulation. The contact gaskets 160, 260 can form a seal around the openings made by the teeth 150A,B 152A,B 250A,B 252A,B to prevent the ingress of water during use.

In certain operations, the second or tap conductor may be inserted into the connector 100 first and then the connector 100 may be placed adjacent a first or main conductor with a hot stick (not shown) or other suitable utility lineman's pole. The end of the tap conductor can be sealed with the conductor seal 116 to help prevent corrosion of the tap line.

The primary conductor can be inserted in the connection 100 by pushing the first conductor against the inner surfaces of the legs 138, 238. The force exerted by the first conductor against the inner surfaces overcomes the force of the spring member 106 and causes the second pad 202 to pivot away from the first pad 106. The first conductor can then be slid between the first conductor grooves 128, 228. Once the first conductor is seated in the first conductor grooves 128, 228, the force exerted by the spring member 106 then causes the second pad 202 to pivot back toward the first pad 102, thereby clamping shut such that the insulation piercing contacts 146A,B 246A,B engage and secure the first conductor in the first conductor grooves 128, 228. The spring member 106 can apply enough force for the teeth 150A,B, 250A,B to pierce the insulation of an insulated first conductor, particularly when the nut 114 is threaded on the bolt 110, or the connector may be compressed by a user to pierce the insulation. Again, the contact gaskets 160, 260 can be compressed to expose the teeth 150A,B 152A,B 250A,B 252A,B and the gaskets 160, 260 can form a seal around the openings made by the teeth 150A,B 152A,B 250A,B 252A,B to prevent the ingress of water during use.

The insulation piercing contacts 146A,B 246A,B provide an electrical path through the connector 100 between the received first and second conductors. Although, the second conductor is typically inserted first, followed by connecting the clamp to the first conductor, in certain implementations a user may insert the first conductor and then the second conductor. The clamp can receive various size and types of conductors as needed.

The installation described above may be accomplished by attaching a utility lineman's hot stick to an end of the fastener and/or the nut extending from the second pad; such as by screwing on to the end of the bolt for example. Various types of mechanical fasteners may used in any of the embodiments described above, including those having hooks or eyelets.

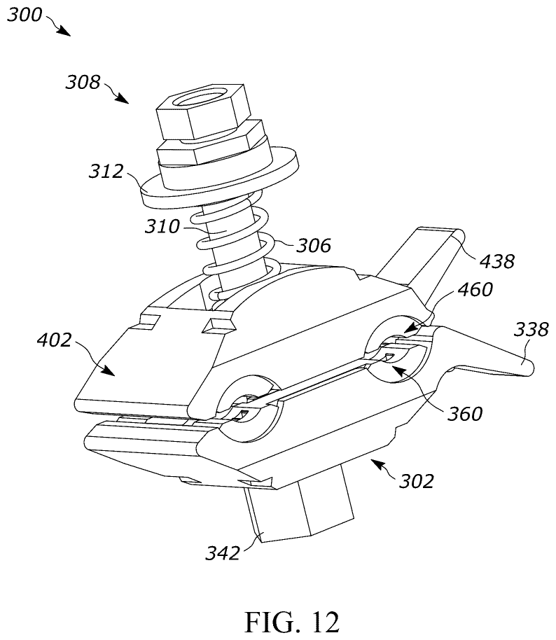

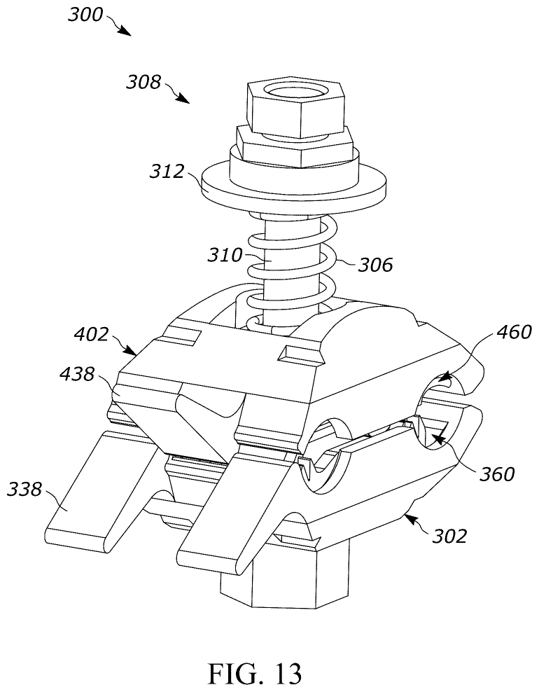

FIGS. 12 and 133 show another exemplary configuration of a connector 300 having a first pad 302, a second pad 402, a spring member 306, and a fastener 308. The fastener 308 secures the spring member 306 against the second pad 402 to bias the first and second pads 302, 402 toward one another. The spring member 306 also provides a clamping force to secure first and second conductors between the first and second pads 302, 402.

The fastener 308 can include a bolt 310, a washer 312, and a shear nut 314. The shear nut 314 can include an upper engagement portion, a frangible section, and a lower engagement portion. A tool can be used to tightening the shear nut 314 using the upper engagement portion until a certain torque limit is reached and the frangible section shears to remove the upper engagement portion. This helps prevent overtightening of the fastener which can cause damage to the connector or to the conductors.

One or more conductor seals can also be utilized with the connector 300. The conductor seals can be placed over an exposed portion of a conductor. For example, the free end of the tap conductor can have an exposed end without insulation. The conductor seal can be used to cover that free end to prevent water or debris from entering the tap line which can lead to corrosion.

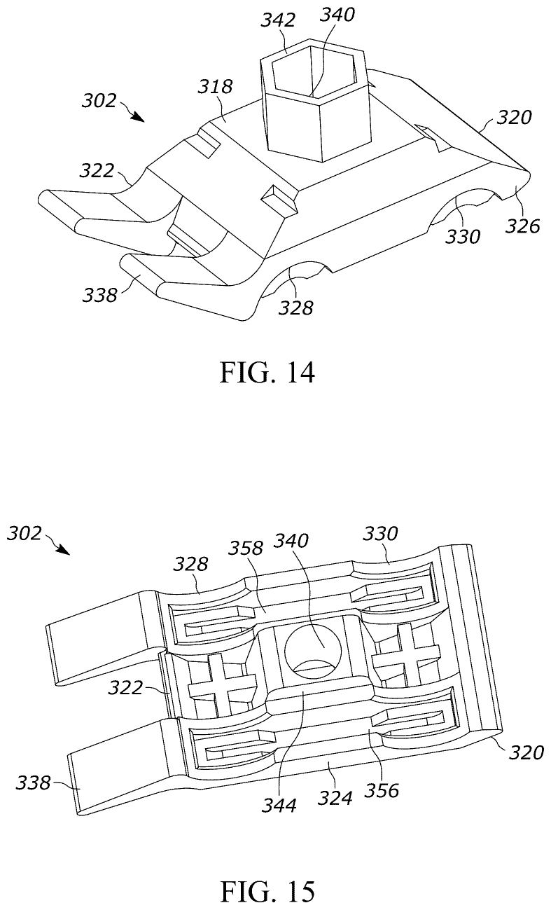

FIGS. 14-16 show an exemplary configuration of the first pad 302 having an outer surface 320, a first end 322, a second end 322, a first side 324, and a second side 326. The first pad 302 can be a one-piece member or can be made from multiple connected components. The first pad 302 can be fabricated from an electrically conductive material, for example metal, or from a non-electrically conductive material, such as a polymer or composite material. The first pad 302 includes a first conductor groove 328 and a second conductor groove 330. The first and second conductor grooves 328, 330, are substantially parallel to one another and are configured to receive the first and second conductors respectively. The first and second conductor grooves 328, 330 are arcuate or partially cylindrical grooves extending between the first side 324 and the second side 326. In various configurations, the size, shape, length, and orientation of the first and second conductor grooves can vary, for example, depending on the type of conductors to be connected and the direction in which the conductors are to run.

The first end 320 of the first pad 302 can include a raised lip 336 extending from the first conductor groove 328. The second end 322 of the first pad 302 can include one or more legs 338 extending at an oblique angle from a lower surface. The angle of the legs 338 allows a user to grip the outer surface and apply pressure to pivot the first and second pads 302, 402 with respect to each other.

The first pad 302 includes a fastener opening 340 extending through the outer surface 318 to receive the bolt 310. An outer projections 342 extends from the outer surface 318 proximate the opening 340. The projection 342 can have a hexagonal configuration can help to retain the head of the bolt 310 to prevent rotation when the sheer nut 314 is being tightened without the need to use a separate tool.

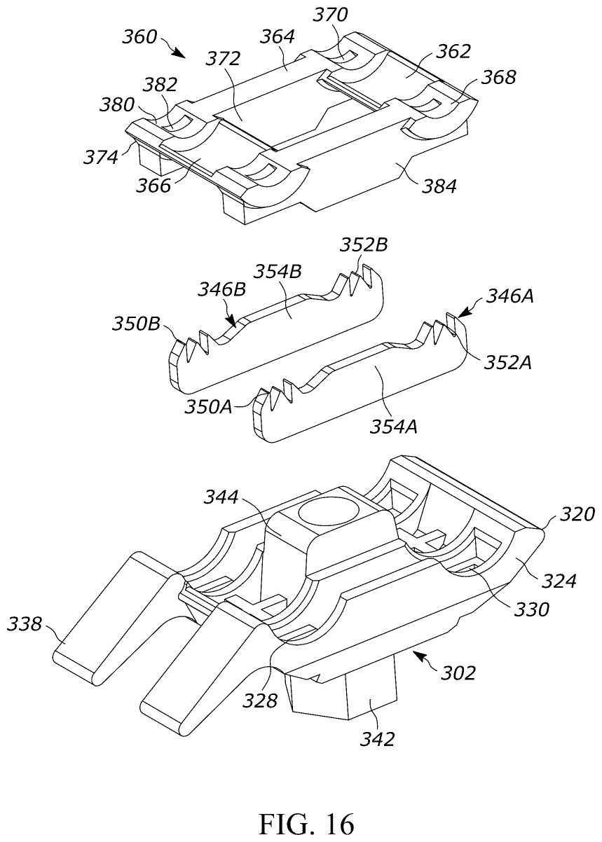

A sleeve 344 extends from the inner portion of the first pad 302 (as shown in FIGS. 15 and 16). The sleeve 344 can have a rectangular or trapezoidal configuration with rounded upper corners and a cylindrical inner opening that receives the fastener bolt 310. The sleeve 344 can vary in size and shape depending on the type of fastener 308 used to connect the first and second pads 302, 402. In certain configurations, the sleeve 344 is integrally formed with the first pad 302.

At least one insulation displacing contact can be connected to the first pad 302. As shown in FIG. 16, a first contact 346A extends between the first conductor groove 328 and the second conductor groove 330 on a first side of the first pad 302. A second contact 346B extends between the first conductor groove 328 and the second conductor groove 330 on a second side of the first pad 302. Each contact 346A, 346B includes a first set of teeth 350A, 350B, a second set of teeth 352A, 352B, and a central portion 354A, 354B, bridging the first teeth 350A, 350B and second teeth 152A, 152B. The first and second insulation displacing contacts 346A, 346B are depicted as single piece or unitary contacts that create an electrical connection between the first and second conductor grooves 328, 330, although a multi-piece contact may also be used.

In certain configurations, the first pad 302 can include a first slot 356 for receiving the first contact 346A and a second slot 358 for receiving the second contact 346B as best shown in FIG. 15. The first and second slots 356, 358 extend into the first pad 302 and from the first conductor groove 328 to the second conductor groove 330 on either side of the sleeve 344. The first and second slots 356, 358 can be blind slots that extend into an inner surface of the first pad 302 in a stepped fashion, with the a central portion being recessed from the outer ends.

The insulation displacing contacts 346A, 346B facilitate engaging an insulated conductor and displacing the insulation. In certain applications, the teeth are designed to pierce the insulation of a respective conductor. The electrical connector also may be used with conductors that do not have insulation, and the insulation displacing contacts may be used to grip or retain the conductor.

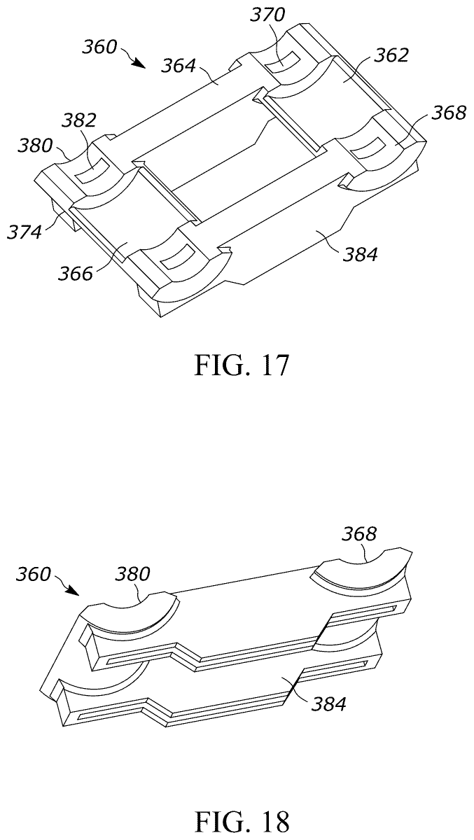

In certain configurations, a first contact gasket 360 is connected to the first pad 302. As best shown in FIGS. 17 and 18, the contact gasket 360 includes a front portion 362, a central region 364, and a rear portion 366. The front portion 362 can be positioned inside of the lip 336 of the first pad 302 and can be in engagement with the lip 336 to help hold the gasket 360 in place. The front portion 362 includes a pair of curved sections 368 corresponding with the second conductor groove 330. A pair of slots 370 are formed in opposite sides of the gasket 360 to receive the first conductor groove teeth 352A, 352B of the contacts 346A, 346B. The first gasket 360 can be configured so that in an unstressed position the teeth 352A, 352B do not extend outside the slots 370, but are positioned below an outer edge surrounding the slots 370. In other configurations, a small portion of the teeth 352A, 352B can extend outside of the slots 370. For example, less than half of the teeth 352A, 352B can extend outside of the slots 370. In a further example, less than a quarter of the teeth 352A, 352B can extend outside of the slots 370.

The central region 364 extends between the front portion 362 and the rear portion 366. The central region 364 includes an upper surface that aligns with upper edges of the front portion 362 and the rear portion 366. An opening 372 extends through the central region 364 to receive the sleeve 344.

The rear portion 366 of the first contact gasket 360 can include a rear edge 374. The rear portion 366 includes a pair of curved sections 380 corresponding with the first conductor groove 328. A pair of slots 182 are formed in opposite sides of the gasket 360 to receive the first conductor groove teeth 350A, 350B of the contacts. The first gasket 360 can be configured so that in an unstressed position the teeth 350A, 350B do not extend outside the slots 382, but are positioned below an outer edge surrounding the slots 382, or extend only partially outside of the slots 382 as described with respect to the front slots 370.

As shown in FIG. 18, a lower portion of the first contact gasket 360 includes a pair of tongues 384 configured to be received in the contact slots 356, 358 of the first pad 302. The tongues 384 have a stepped configuration and extend away from the upper surface of the first contact gasket 360. The tongues 384 can have a hollow section and be in communication with the slots 370, 382 on the respective sides of the first contact gasket 360.

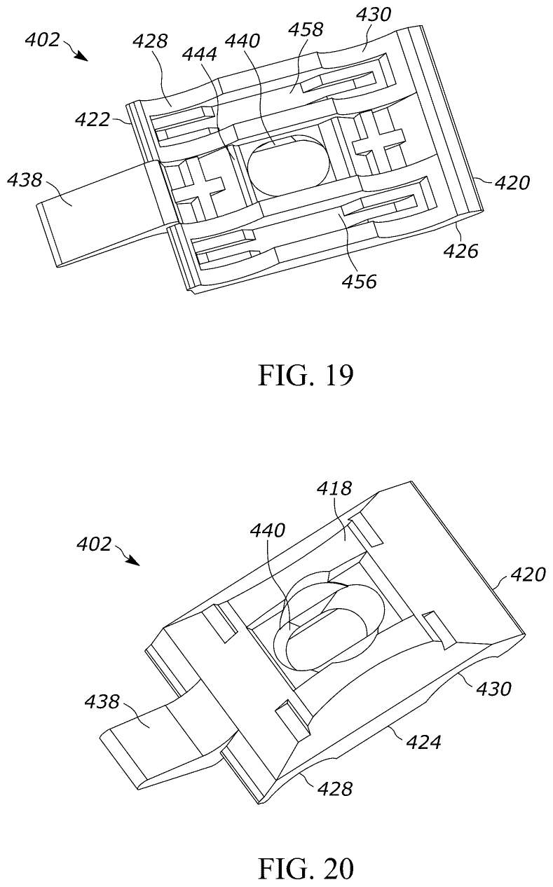

As best shown in FIGS. 19-20, the second pad 402 includes an outer surface 418, a first end 420, a second end 422, a first side 424, and a second side 426. The second pad 402 can be a one-piece member. The second pad 402 can be fabricated from an electrically conductive material, for example metal, or from a non-electrically conductive material, such as a polymer or composite material. The second pad 402 includes a first conductor groove 428 and a second conductor groove 430. The first and second conductor grooves 428, 430, are substantially parallel to one another and are configured to receive the first and second conductors respectively. The first and second conductor grooves 428, 430 are arcuate or partially cylindrical grooves extending between the first side 424 and the second side 426. In various configurations, the size, shape, length, and orientation of the first and second conductor grooves 428, 430 can vary, for example, depending on the type of conductors to be connected and the direction in which the conductors are to run.

The front 420 of the second pad 402 can include a raised lip 436 extending from the first conductor groove 428. The rear 422 of the second pad 402 can include a leg 438 extending at an oblique angle from an upper surface. The angle of the leg 438 allows a user to grip the outer surface and apply pressure to pivot the first and second pads 302, 402 with respect to each other.

The second pad 402 includes a fastener opening 440 extending through an outer surface to receive the bolt 310. A recess 442 is formed around the opening 440. The recess 442 has an obround shape and is configured to receive the washer and shear nut of the fastener. A pair of projections 444 extend from the interior of the second pad 402 around the fastener opening 440. The projections 444 can have an angled configuration so that they extend toward one another. The projections can be figured to engage the sleeve 344.

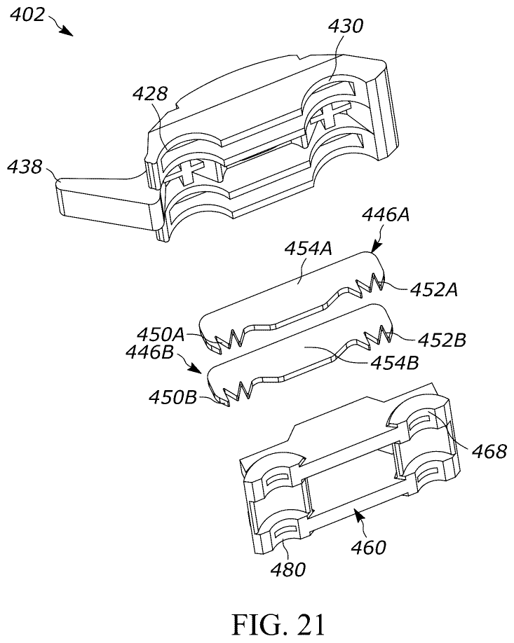

At least one insulation displacing contact can be connected to the second pad 402. As shown in FIG. 21, a first contact 446A extends between the first conductor groove 428 and the second conductor groove 430 on a first side of the second pad 402. A second contact 446B extends between the first conductor groove 428 and the second conductor groove 430 on a second side of the second pad 402. Each contact 446A, 446B includes a first set of teeth 450A, 450B, a second set of teeth 452A, 452B, and a central portion 454, bridging the first teeth 450A, 450B and second teeth 452A, 452B. The first and second insulation displacing contacts 446A, 446B are depicted as single piece or unitary contacts that create an electrical connection between the first and second conductor grooves 428, 430, although a multi-piece contact may also be used.

In certain configurations, the second pad 402 can include a first slot 456 for receiving the first contact 446A and a second slot 458 for receiving the second contact 446B. The first and second slots 256, 258 extend into the second pad 202 and from the first conductor groove 428 to the second conductor groove 438 on either side of the fastener opening 440. The first and second slots 456, 458 can be blind slots that extend into an inner surface of the first pad 202 in a stepped fashion with the a central portion being recessed from the outer ends.

In certain configurations, a second contact gasket 460 is connected to the second pad 402. The second contact gasket 460 can have a configuration similar or identical to the first contact gasket 160 shown in FIGS. 16-18. In some configurations, the first contact gasket 360 and/or second contact gasket 460 can be different than what is shown based on the application and the conductors to be connected.

In operation, the first and second pads 302, 402 are assembled together to form a spring-loaded connector 300. The first conductor grooves 328, 428 are aligned to form a receiving area for a first conductor. The second conductor 330, 430 grooves are aligned to form a receiving area for the second conductor.

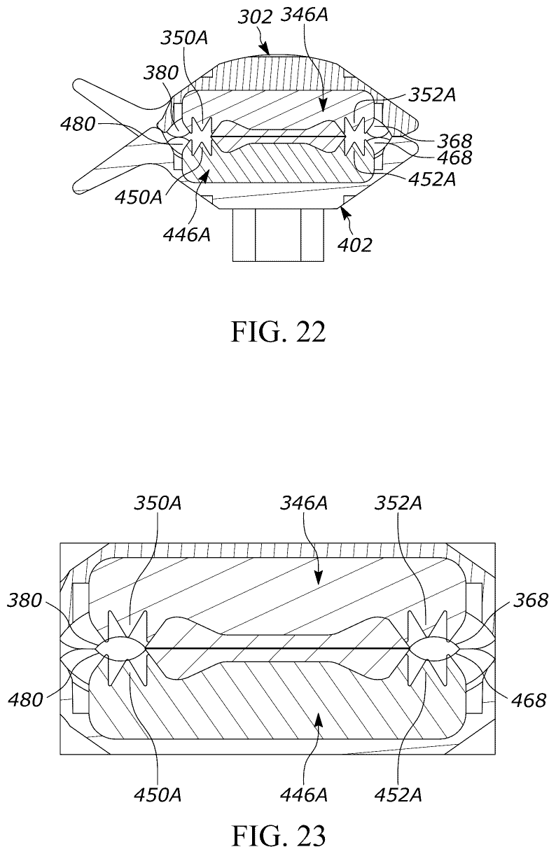

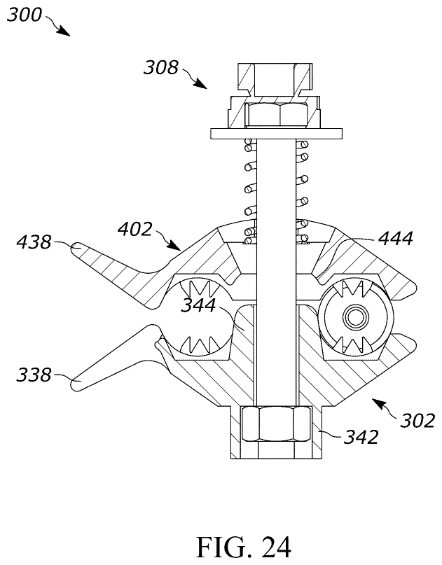

In certain configurations, as best shown in FIGS. 22 and 23, inner edges of the pads 302, 402 and the gaskets 360, 460 can be substantially aligned to allow the pads 302, 402 to securely seat against one another. This can help reduce costs of storage and allow for more secure transport of the connector 300 prior to installation.

In certain configurations, the teeth 350A, 350B, 352A, 352B, 450A, 450B, 452A, 452B can be offset from the conductor groves 328, 330, 428, 430 and/or the curved sections 368, 380, 468, 480 of the gaskets 360, 460. For example, the teeth 350A, 350B, 352A, 352B, 450A, 450B can each include a plurality of teeth and the central tooth can be offset from the center of the cable groove 328, 330, 428, 430 toward the center of the pads 302, 304. In the illustrated embodiment, as best shown in FIG. 23, the teeth 350A, 350B, 352A, 352B, 450A, 450B, 452A, 452B include three teeth, with the central tooth spaced from the center point of the curved sections 368, 380, 468, 480 of the gaskets 360, 460. While a substantial portion of the teeth are below the gaskets 360, 460, the offset spacing can result in the outer tooth extending into the opening slightly more than the inner tooth. This offset spacing can help pull conductors inward toward the center of the connector 300 during clamping. This can result in increased hold and cable retention, while also allowing for a better conductive connection.

During installation, the spring 306 applies pressure against the second pad 402, forcing or biasing the first and second pads 302, 402 together. The first and second pads 302, 402 can be separated by overcoming the pressure exerted by the spring member 306 to allow for installation of the conductors between the conductor grooves of the first and second pads 302, 402. As the first and second pads 302, 402 are forced against each other by the spring member 306, pressure is created on the conductors such that the insulation displacing contacts 346A,B 446A,B engage the conductors to secure the conductors in the conductor grooves 328, 330, 428, 430.

The force of the spring member 306 may also be sufficient for the teeth 350A,B 352A,B 450A,B 452A,B to pierce the insulation of the conductor. During this operation, the contact gaskets 360, 460 can be compressed so that the teeth 350A,B 352A,B 450A,B 452A,B extend out, or further, from the respective slots 370, 382 and engage the conductor, piercing the insulation. The contact gaskets 360, 460 can form a seal around the openings made by the teeth 350A,B 352A,B 450A,B 452A,B to prevent the ingress of water during use.

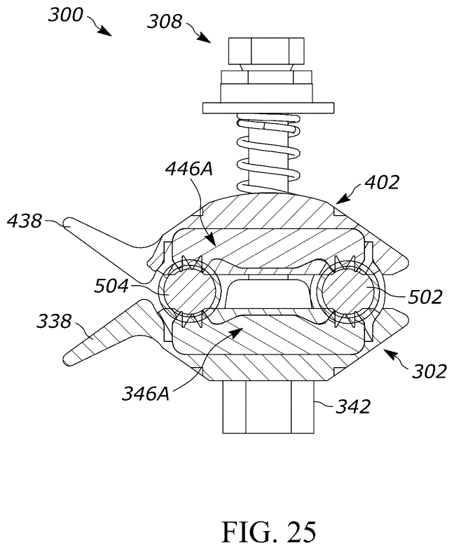

FIG. 25 shows an installation of a tap conductor 502 and a primary conductor 504. In certain operations, the second or tap conductor 502 may be inserted into the connector 300 first and then the connector 300 may be placed adjacent a first or main conductor 504 with a hot stick (not shown) or other suitable utility lineman's pole. The end of the tap conductor can be sealed with the conductor seal 116 to help prevent corrosion of the tap line.

The primary conductor can be inserted in the connection 300 by pushing the first conductor against the inner surfaces of the legs 338, 438. The force exerted by the first conductor against the inner surfaces overcomes the force of the spring member 306 and causes the second pad 402 to pivot away from the first pad 306. In certain configurations, the sleeve 344 of the first pad 302 can be pivoted on the projections 444 of the second pad 402. The first conductor can then be slid between the first conductor grooves 328, 428.

Once the first conductor is seated in the first conductor grooves 328, 428, the force exerted by the spring member 306 then causes the second pad 402 to pivot back toward the first pad 302, thereby clamping shut such that the insulation piercing contacts 346A,B 446A,B engage and secure the first conductor in the first conductor grooves 328, 428. The spring member 306 can apply enough force for the teeth 450A,B, 450A,B to pierce the insulation of an insulated first conductor, particularly when the nut 314 is threaded on the bolt 310, or the connector may be compressed by a user to pierce the insulation. Again, the contact gaskets 360, 460 can be compressed to expose the teeth 350A,B 352A,B 450A,B 452A,B and the gaskets 360, 460 can form a seal around the openings made by the teeth 350A,B 352A,B 450A,B 452A,B to prevent the ingress of water during use.

The insulation piercing contacts 346A,B 446A,B provide an electrical path through the connector 100 between the received first and second conductors. Although, the second conductor is typically inserted first, followed by connecting the clamp to the first conductor, in certain implementations a user may insert the first conductor and then the second conductor. The clamp can receive various size and types of conductors as needed.

The foregoing detailed description has been provided for the purpose of explaining the general principles and practical application, thereby enabling others skilled in the art to understand the disclosure for various configurations and implementations, and with various modifications as are suited to the particular uses contemplated. This description is not necessarily intended to be exhaustive or to limit the disclosure to what is disclosed. Any of the configurations and/or elements disclosed herein may be combined with one another to form various additional embodiments not specifically disclosed. Accordingly, additional configurations and implementations are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings. The words “member,” “component,” “module,” “mechanism,” “element,” “device,” and the like are not a substitute for the word “means.” As such, no claim element should be construed as a means plus function unless the element is expressly recited using the phrase “means for.”

What is claimed:

1. An electrical connector comprising:
a first pad having a first conductor groove and a second conductor groove;
a second pad having a third conductor groove and a fourth conductor groove, the second pad movably connected to the first pad by a fastener;
an electrically conductive first contact connected to the first pad, the first contact having a first set of teeth extending into the first groove and a second set of teeth extending into the second groove;
a first contact gasket connected to the first pad and positioned over the first contact, the first contact gasket having a first slot aligned with the first set of teeth and a second slot aligned with the second set of teeth;
an electrically conductive second contact connected to the second pad, the second contact having a third set of teeth extending into the third groove and a fourth set of teeth extending into the fourth groove; and
a second contact gasket connected to the second pad and positioned over the second contact, the second contact gasket having a third slot aligned with the third set of teeth and a fourth slot aligned with the fourth set of teeth.

2. The electrical connector of claim 1, further comprising a conductor seal configured to be positioned on an end of a conductor received by the first pad and the second pad.

3. The electrical connector of claim 1, wherein the fastener extends through an opening in the first pad and an opening in the second pad.

4. The electrical connector of claim 3, wherein the fastener extends through a sleeve in the first pad.

5. The electrical connector of claim 4, wherein the sleeve has a cylindrical configuration.

6. The electrical connector of claim 4, wherein the sleeve has a trapezoidal configuration.

7. The electrical connector of 6, wherein a pair of projections extend form the second pad opposite the sleeve.

8. The electrical connector of claim 1, wherein the first contact gasket includes a first curved section aligned with the first conductor groove and a second curved section aligned with the second conductor groove.

9. The electrical connector of claim 1, wherein at least a substantial portion of the first teeth are positioned below an outer edge surrounding the first slot when the conductor gasket is in an uncompressed state.

10. The electrical connector of claim 1, wherein the first set of teeth are offset from the first conductor groove and the second set of teeth are offset from the second conductor.

11. An electrical connector comprising:
a first pad;
a second movably connected to the first pad by a fastener;
an electrically conductive first contact connected to the first pad, the first contact having a first set of teeth and a second set of teeth;
a first contact gasket connected to the first pad and positioned over the first contact, the first contact gasket having a first curved portion for receiving a first conductor, a second curved portion for receiving a second conductor, a first slot aligned with the first set of teeth, and a second slot aligned with the second set of teeth;
an electrically conductive second contact connected to the second pad, the second contact having a third set of teeth and a fourth set of teeth; and
a second contact gasket connected to the second pad and positioned over the second contact, the second contact gasket having a third slot aligned with the third set of teeth and a fourth slot aligned with the fourth set of teeth.

12. The electrical connector of claim 11, wherein the fastener extends through an opening in the first pad and an opening in the second pad.

13. The electrical connector of claim 12, wherein the fastener extends through a sleeve in the first pad.

14. The electrical connector of claim 13, wherein the sleeve has a cylindrical configuration.

15. The electrical connector of claim 13, wherein the sleeve has a trapezoidal configuration.

16. The electrical connector of 15, wherein a pair of projections extend form the second pad opposite the sleeve.

17. The electrical connector of claim 11, wherein the first contact gasket includes a first curved section aligned with the first conductor groove and a second curved section aligned with the second conductor groove.

18. The electrical connector of claim 11, wherein at least a substantial portion of the first teeth are positioned below an outer edge surrounding the first slot when the conductor gasket is in an uncompressed state.

19. The electrical connector of claim 11, wherein the first set of teeth are offset from the first conductor groove and the second set of teeth are offset from the second conductor.

20. The electrical connector of claim 11, wherein the first pad includes an outer projection configured to resist rotation of a portion of the fastener.
